(19) United States
(12) Patent Application Publication
(10) Pub. No.: US 2026/0024198 A1
(43) Pub. Date: Jan. 22, 2026

(54) APPARATUS AND METHOD FOR CLASSIFYING SUBTYPE OF RENAL TUMOR

(71) Applicant: MedAI CO., LTD., Seoul (KR)

(72) Inventor: Sung-Jea KO, Seoul (KR)

(21) Appl. No.: 18/957,211

(22) Filed: Nov. 22, 2024

(30) Foreign Application Priority Data
Jul. 16, 2024 (KR) 10-2024-0093906

(51) Int. Cl. G06T 7/00; G06T 7/10

(52) U.S. Cl. CPC G06T 7/0012; G06T 7/10; G06T 2207/10081; G06T 2207/30096

(57) ABSTRACT

An apparatus for classifying subtypes of tumors includes: a lesion segmentation network module for extracting lesion segmentation maps from multi-phase CT images; a lesion-level feature embedding module for acquiring lesion-level feature embeddings using the multi-phase CT images and the lesion segmentation maps; a cross-phase attention module for acquiring an attention weight matrix representing interdependence of multi-phase pairwise lesion features using the feature embeddings and combining the feature embeddings and the attention weight matrix to produce an output feature matrix; and a feed forward network module for predicting a probability for the classification of the subtypes of tumors through the input of the output feature matrix.

### CROSS REFERENCE TO RELATED APPLICATION OF THE DISCLOSURE

The present application claims the priority and benefit of Korean Patent Application No. 10-2024-0093906 filed in the Korean Intellectual Property Office on Jul. 16, 2024, the entire contents of which are incorporated herein by reference.

### BACKGROUND OF THE DISCLOSURE

### Field of the Disclosure

The present disclosure relates to an apparatus and method for classifying subtypes of tumors, more specifically to an apparatus and method for classifying subtypes of tumors that on multi-phase computed tomography (CT) images.

### Background of the Related Art

A kidney cancer is one of the most common cancers in the world, and in 2021, about 76,080 new diagnosis cases for kidney cancers occur in the United States, so that 13,780 people with kidney cancers are dead. Approximately 90% of all kidney cancers are renal cell carcinomas (RCCs), and according to classification of World Health Organization (WHO) in 2016, the RCC has three main types of clear cell RCC (ccRCC), papillary RCC (pRCC), and chromophobe RCC (chRCC). The prognosis of kidney tumors may be varied according to histological subtypes of kidney tumors, and therefore, the differential diagnosis of a tumor before surgery is necessary in building treatment planning for the tumor.

Medical imaging techniques are widely used for non-invasive diagnosis of kidney tumors, which can avoid a biopsy. Multi-phase CT scanning is considered as the best diagnosis imaging method because it is better than ultrasound in detecting and specializing kidney tumors and due to limited availability of magnetic resonance imaging (MRI). Through such multi-phase CT scanning, a series of CT volumes are acquired during various times before and after injection of a contrast agent. Three contrast-enhanced phases such as an arterial phase, a portal phase, and a delayed phase are acquired in 20 to 30 seconds, 60 to 70 seconds, and 180 seconds after the contrast agent has been injected.

A radiologist compares the contrast-enhanced phase images with non-contrast phase images, analyzes an attenuation value of a lesion and a contrast enhancement pattern, and detects histological subtypes of the kidney lesion. According to studies, ccRCC shows clear contrast enhancement in normal and delayed phases, and pRCC and chRCC shows high contrast enhancement in the portal phase. In addition to the degree of contrast enhancement, different lesion features such as uniformity of enhancement and calcification may be used for differential diagnosis.

However, the kidney tumors have minute image feature differences among the subtypes thereof, and even the same types of kidney lesions have various enhancement patterns according to CT phases. Therefore, even visual estimation made by radiologists with a lot of experiences may be different from one another. Further, benign kidney lesions such as fat-poor angiomyolipoma and oncocytoma are often diagnosed wrongly as renal cell carcinoma, thereby causing unnecessary surgery.

Therefore, there is a need to develop a new apparatus and method for accurately diagnosing renal cell carcinoma.

### SUMMARY OF THE DISCLOSURE

Accordingly, the present disclosure has been made in view of the above-mentioned problems occurring in the related art, and it is an object of the present disclosure to provide an apparatus and method for classifying subtypes of tumors on multi-phase CT images.

To accomplish the above-mentioned objects, according to an aspect of the present disclosure, there is provided an apparatus for classifying subtypes of tumors including: a lesion segmentation network module for extracting lesion segmentation maps from multi-phase CT images; a lesion-level feature embedding module for acquiring lesion-level feature embeddings using the multi-phase CT images and the lesion segmentation maps; a cross-phase attention module for acquiring an attention weight matrix representing interdependence of multi-phase pairwise lesion features using the feature embeddings and combining the feature embeddings and the attention weight matrix to produce an output feature matrix; and a feed forward network module for predicting a probability for the classification of the subtypes of tumors through the input of the output feature matrix.

To accomplish the above-mentioned objects, according to another aspect of the present disclosure, there is provided a method for classifying subtypes of tumors including the steps of: extracting lesion segmentation maps from multi-phase CT images; acquiring lesion-level feature embeddings using the multi-phase CT images and the lesion segmentation maps; acquiring an attention weight matrix representing interdependence of multi-phase pairwise lesion features using the feature embeddings and combining the feature embeddings and the attention weight matrix to produce an output feature matrix; and predicting a probability for the classification of the subtypes of tumors through the input of the output feature matrix.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a block diagram showing an apparatus for classifying subtypes of tumors according to the present disclosure;

FIG. 2 shows examples of multi-phase CT scanned images of five subtype samples of renal tumors according to the present disclosure;

FIG. 3 shows a framework for explaining operations of the apparatus for classifying subtypes of tumors according to the present disclosure;

FIG. 4 shows a multi-scale attention method;

FIG. 5 shows a baseline of a multi-phase CT image;

FIG. 6 shows visualized low-level and high-level attention weight matrixes according to phases; and

FIG. 7 is a flowchart showing a method for classifying subtypes of tumors according to the present disclosure.

### DETAILED DESCRIPTION OF THE PREFERRED EMBODIMENT

The present disclosure as will be discussed below will be made with reference to the attached drawings in which embodiments of the present disclosure are implemented. The embodiments of the present disclosure will be explained in detail so that they will be carried out by a person of ordinary skill in the art. The embodiments of the present disclosure are different from one another, but it should be understood that they do not need to be mutually exclusive. For example, specific shape, structure and features of an embodiment of the present disclosure as mentioned herein may be present in other embodiments of the present disclosure within the spirit and scope of the present disclosure. Further, the positions or arrangements of individual components in embodiments of the present disclosure may be varied within the spirit and scope of the present disclosure. Therefore, it is manifestly intended that this disclosure be limited only by the claims and the equivalents thereof. In the drawings, the corresponding parts in the embodiments of the present disclosure are indicated by corresponding reference numerals.

Further, the components of the present disclosure may be components defined by function division, not by physical division, and therefore, they may be defined by means of the functions performed. The components may be implemented as hardware or program codes and processing units or processors performing their function, and the functions of two or more components may be performed in one component. Therefore, the names applied to the components in the embodiments as will be discussed later are given to imply representative functions performed by the components, not to physically divide the components. Of course, it should be noted that the technical idea of the present disclosure may not be limited by the names of the components.

Now, an explanation of an embodiment of the present disclosure will be given in detail with reference to the attached drawings.

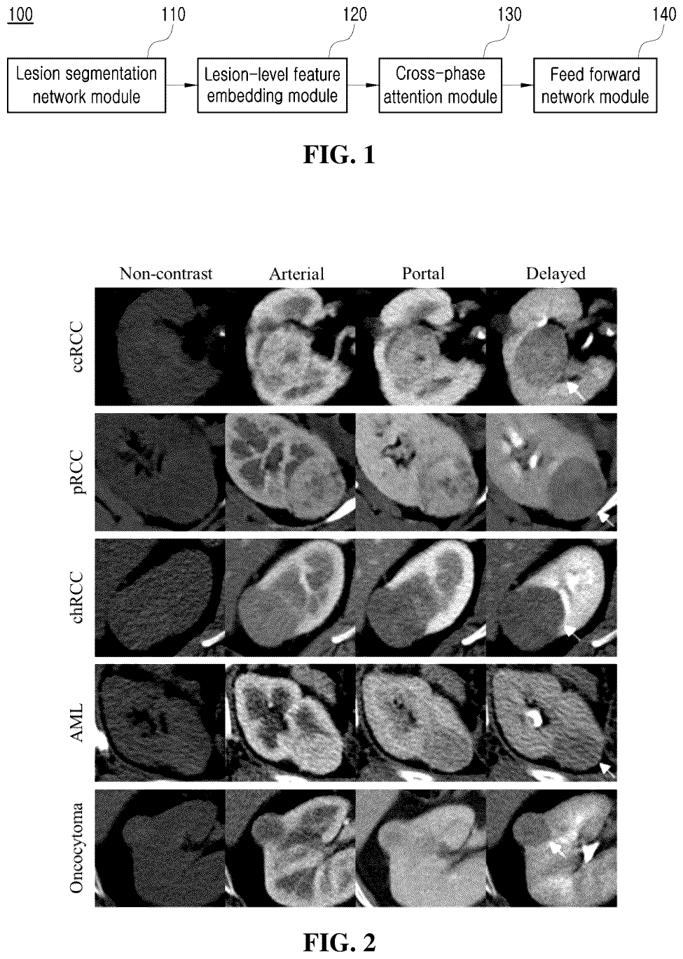

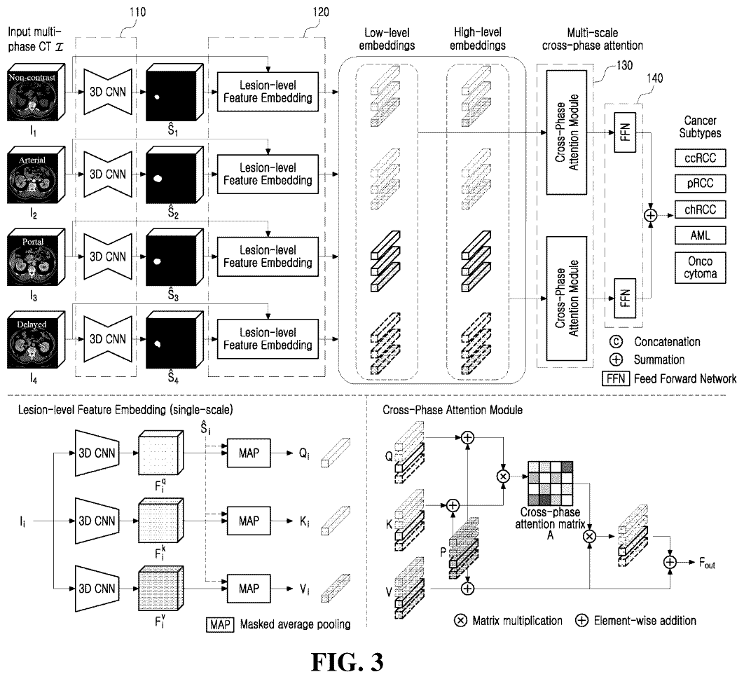

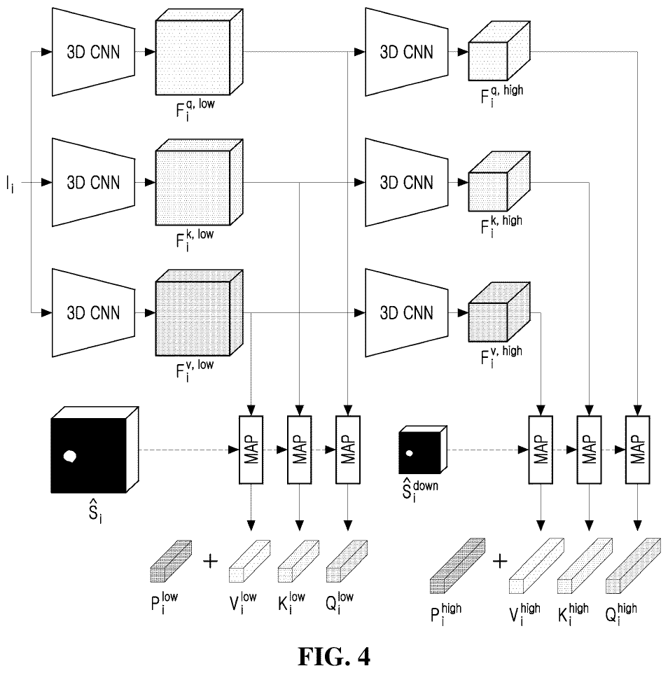

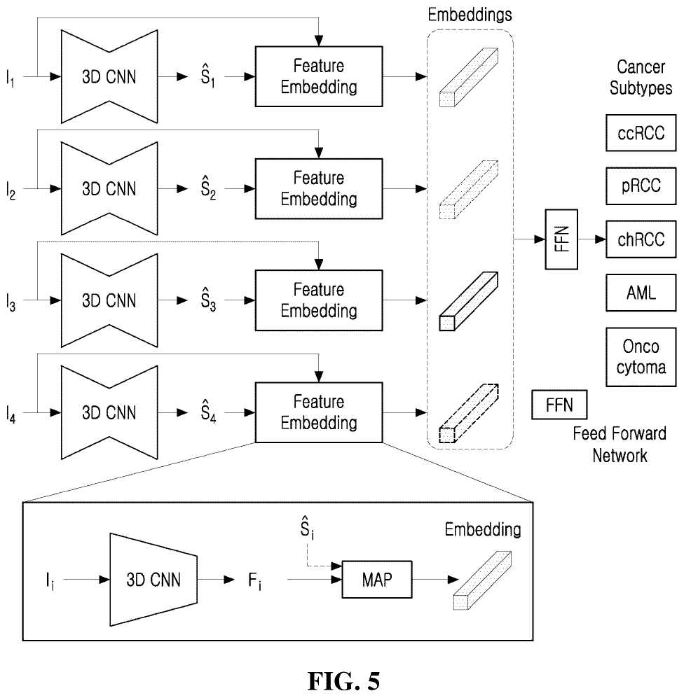

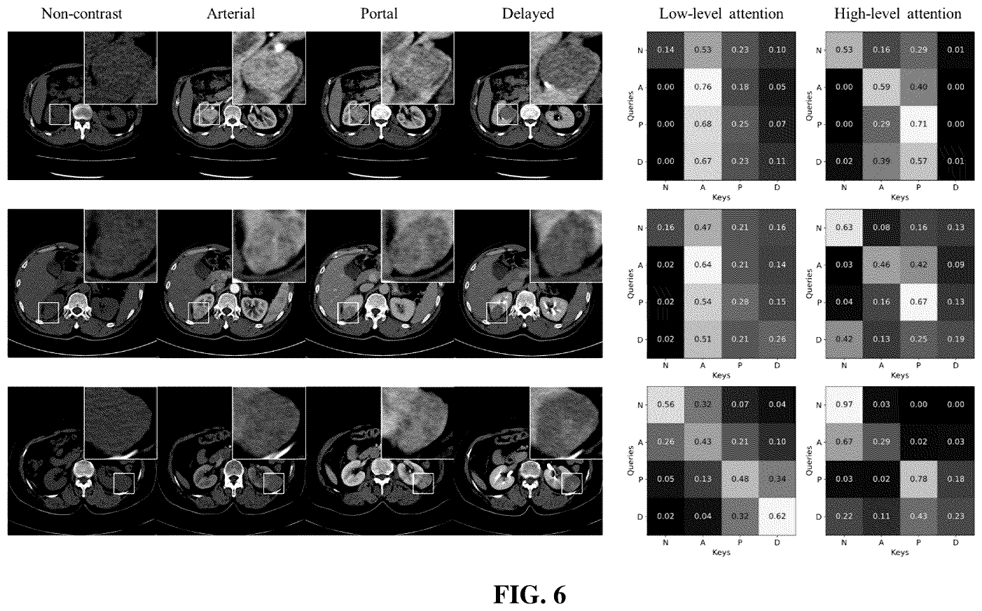

FIG. 1 is a block diagram showing an apparatus for classifying subtypes of tumors according to the present disclosure, FIG. 2 shows examples of multi-phase CT scanned images of five subtype samples of renal tumors according to the present disclosure, FIG. 3 shows a framework for explaining operations of the apparatus for classifying subtypes of tumors according to the present disclosure, FIG. 4 shows a multi-scale attention method, FIG. 5 shows a baseline of a multi-phase CT image, and FIG. 6 shows visualized low-level and high-level attention weight matrixes according to phases.

As shown in FIG. 1, an apparatus 100 for classifying subtypes of tumors according to the present disclosure includes a lesion segmentation network module 110, a lesion-level feature embedding module 120, a cross-phase attention module 130, and a feed forward network (FFN) module 140. In the present disclosure, for example, operations of classifying subtypes of renal tumors through the apparatus 100 for classifying subtypes of tumors according to the present disclosure will be explained, but the apparatus 100 for classifying subtypes of tumors according to the present disclosure may be of course adopted in classifying subtypes of other tumors.

The lesion segmentation network module 110 extracts lesion segmentation maps Ŝᵢ from multi-phase CT images Iᵢ. In this case, as shown in FIG. 2, multi-phases include a non-contrast phase, an arterial phase, a portal phase, and a delayed phase.

The lesion-level feature embedding module 120 acquires lesion-level feature embeddings using the CT images and the lesion segmentation maps. That is, the lesion-level feature embedding module 120 produces a plurality of feature maps from the CT images, and transforms the plurality of feature maps into queries Qᵢ, keys Kᵢ, and values Vᵢ using the lesion segmentation maps, and acquires the lesion-level feature embeddings.

The cross-phase attention module 130 acquires an attention weight matrix A representing interdependence of multi-phase pairwise lesion features using the feature embeddings and combines the feature embeddings and the attention weight matrix A to produce an output feature matrix Fₒᵤₜ.

The FFN module 140 predicts a probability ŷ for the classification of the subtypes of tumors through the input of the output feature matrix.

Now, an explanation of the operations of the apparatus 100 for classifying subtypes of tumors according to the present disclosure will be given in detail with reference to FIG. 3. It is assumed that

$$I = {\{ {l}_{i} \}}_{i = 1}^{N}$$

is a collection of CT scan images. In this case, the N is the number of CT phases, and Iᵢ∈R^{H×W×D} is i-th image of the corresponding phase with resolution of H, W, and D. For example, if images in the non-contrast phase, the arterial phase, the portal phase, and the delayed phase during the scanning are acquired, the N is 4.

First, the lesion segmentation map Ŝᵢ∈{0,1}^{H×W×D} is extracted from each image Iᵢ through the lesion segmentation network module 110. In this case, the number 1 represents that a voxel is in a tumor region and the number 0 represents that a voxel is not in a tumor region. In detail, the lesion segmentation network module 110 is based on a 3D convolutional neural network (CNN) and shares network weights in some phases.

Next, each pair of Iᵢ and Ŝᵢ is inputted to the lesion-level feature embedding module 120 to analyze development patterns of renal lesions at the respective phases i. As shown in the left bottom of FIG. 3, three individual networks produce three feature maps

$$\begin{matrix}{F}_{i}^{q} , {F}_{i}^{v} ∈ \\ {R}^{H \times W \times D \times C}\end{matrix}$$

from the input image Iᵢ. In this case, the C represents the number of channels, and each network has two 3×3×3 convolutional layers having instance normalization and leaky Rectified Linear Unit (ReLU) activation. To express lesion-level features, the three feature maps are transformed into Qᵢ, Kᵢ, and Vᵢ through Masked Average Pooling (MAP) using the predicted lesion segmentation map Ŝᵢ, which are suggested in the following mathematical expression 1.

$$[ Mathematical expression 1 ]$$

$${Q}_{i} = MAP ( {F}_{i}^{q} , {\hat{S}}_{i} ) , {K}_{i} = MAP ( {F}_{i}^{k} , {\hat{S}}_{i} ) , {V}_{i} = MAP ( {F}_{i}^{υ} , {\hat{S}}_{i} )$$

In this case, Qᵢ, Kᵢ, and Vᵢ ∈R^{c}, and MAP (⋅,⋅) represents a MAP operation, which is formulized as suggested in the following mathematical expression 2.

$$[ Mathematical expression 2 ]$$

$$MAP ( F , \hat{S} ) = [ \frac{{\sum }_{x {∈}_{χ}} F ( x , c ) \hat{S} ( x )}{{\sum }_{x {∈}_{χ}} \hat{S} ( x )} ] , c = 1 , 2 , … , C$$

In this case, the x represents 3D coordinates, and the X represents a collection of all 3D space positions of F and S. Relations among the phases for classifying the subtypes of tumors are captured by the use of the extracted feature embeddings Qᵢ, Kᵢ, and Vᵢ, as query, key, and value.

After the lesion-level feature embeddings have been acquired, as shown in the right bottom of FIG. 3, a phase embedding P is added to the query, key, and value. First, 1D learnable phase embedding set P is defined as

$${\{ {P}_{i} \}}_{i = 1}^{N} ,$$

and in this case, if it is assumed that Pᵢ ∈R^{C} is i-th phase embedding, the phase embedding Pᵢ is added to query Qᵢ, key Kᵢ, and value Vᵢ and provides information representing the phases to which the feature embeddings belong. After that, modelling for the dependency among the phases is performed using a self-attention mechanism of a transformer. In this case, the query, key, and value matrixes are represented with Q, K, and V, and in detail, i-th rows of the Q, K, and V are given as Qᵢ+Pᵢ, Kᵢ+Pᵢ, and Vᵢ+Pᵢ.

The cross-phase attention module 130 adds the P to the Q and K, calculates a scaled dot product between the Q and K to which the P is added, applies a softmax function to the calculated dot product, and acquires an attention weight matrix A∈R^{N×N}. This represents the interdependence of the multi-phase pairwise lesion features, which is given with the following mathematical expression 3.

$$[ Mathematical expression 3 ]$$

$$A ( Q , K ) = softmax ( \frac{{QK}^{T}}{\sqrt{C}} )$$

The scaled dot product between the Q and K is calculated as similarity between the features of different CT scan images. For example, similarity between the query features of i-th phase and the key features of j-th phase are measured, and therefore, the attention weight matrix A represents the interdependence of the lesion features on different CT phases. Next, the value matrix V to which the phase embedding P is added is multiplicated with the attention weight matrix A to produce the output feature matrix Fₒᵤₜ ∈R^{N×C}, which is given with the following mathematical expression 4.

$${F}_{out} = λ AV + V \qquad [ Mathematical expression 4 ]$$

In this case, the X represents a weight hyperparameter, and empirically, the X is set to 0.1. Through the process, weight is applied to the V according to the attention weight matrix A for the lesion features of the different CT phases, and the interdependence between the different CT phases is reflected, so that the lesion features are improved. Next, the Fₒᵤₜ is changed in shape to acquire 1D fusion feature vector fₒᵤₜ ∈R^{NC}.

Probability prediction ŷ for classifying the subtypes of tumors is produced by the FFN module 140 using the output feature vector fₒᵤₜ as an input (that is, ŷ=softmax(FFN(Fₒᵤₜ)). In this case, the ŷ represents probability distribution for renal tumor subtype classificaiton label, and for example, as shown in FIG. 2, the subtypes of renal tumor include ccRCC, pRCC, and chRCC as renal cell carcinoma and angiomyolipoma (AML) and oncocytoma as benign renal lesions.

Further, the ŷ is a result predicted in a single-scale, and a final output in FIG. 3 is acquired through the multi-scale attension method as will be explained with reference to FIG. 4.

To perform differential diagnosis for the subtypes of renal tumors, it may be helpful that CT image features of the tumors, such as lesion texture features, lesion structure features, and the like are analyzed in multi-scales, not in a single-scale. Therefore, as shown in FIG. 4, so as to allow a model to produce the prediction more accurately, the multi-scale attention method wherein dependence among lesion feature phases is captured in different scales is proposed.

Multi-scale deep features are extracted from three separate encoders, and

$${F}_{i}^{q , low} , {F}_{i}^{k , low} , and {F}_{i}^{v , low} ∈ {R}^{H \times W \times D \times C}$$

are assumed as feature maps of first levels, that is, low-levels produced in two first layers of the respective encoders, whereas

$${F}_{i}^{q , high} , {F}_{i}^{k , high} , and {F}_{i}^{v , high} ∈ {R}^{\frac{H}{2} \times \frac{W}{2} \times \frac{D}{2} \times 2 C}$$

are assumed as feature maps of second levels, that is, high-levels that are higher than the first levels produced from output layers of the respective encoders.

In this case, the low-level features and the high-level features are separated from one another according to degrees of passing through the convolutional layers of the encoders. That is, the low-level features are the features obtained and calculated by passing through a smaller number of convolutional layers than a predetermined number of convolutional layers, and the high-level features are the features that are calculated by passing the calculated low-level features through the convolutional layers and pooling layers.

The components of the first two layers of the encoders are the same as explained in FIG. 3, and the added remaining two 3D convolutional layers are used to extract the high-level features. In this case, the first layer of the added two layers performs 3×3×3 convolutional operation with a stride 2 for downsampling, and encoder weights are shared in all phases.

Next, the predicted lesion segmentation map Ŝᵢ is downsampled to

$$\frac{H}{2} \times \frac{W}{2} \times \frac{D}{2} ,$$

and it corresponds to spatial resolution of the features and the segmentation map. The downsampled lesion segmentation map is represented by

$${\hat{S}}_{i}^{down} .$$

After that, the feature maps of the respective scales are transformed into queries, keys, and values using the lesion segmentation maps of the corresponding scales through the MAP. The low-level feature embeddings

$${Q}_{i}^{low} , {K}_{i}^{low} , and {V}_{i}^{low} ∈ {R}^{C}$$

are acquired using the Ŝᵢ, and the high-level feature embeddings

$${Q}_{i}^{high} , {K}_{i}^{high} , and {V}_{i}^{high} ∈ {R}^{2 C}$$

are acquired using the

$${\hat{S}}_{i}^{down} .$$

1D learnable phase embedding sets for the low-level feature embeddings and the high-level feature embeddings are defined as

$${\{ {P}_{i}^{low} ∈ {R}^{C} \}}_{i = 1}^{N} and {\{ {P}_{i}^{high} ∈ {R}^{2 C} \}}_{i = 1}^{N} ,$$

and the phase embedding of each scale is added to the query, key, and value so that the position information of the phase is kept.

Next, the dependence between the level feature phases of the respective scales is captured through the cross-phase attention module 130 to produce low-level attention weight matrixes A^{low} and high-level attention matrixes A^{high}. In this case, the A^{low} and A^{high} are visualized as shown in FIG. 6. To perform such visualization, representative slices of the CT scan images are marked, and attention values for the respective query-key pairs are marked on the matrixes. The tumor regions (having the highest attention values) are enlarged on the respective phases.

Therefore, the outputs of the cross-phase attention module 130 on the low levels and the high levels are feature matrixes

$${F}_{out}^{low} ∈ {R}^{N \times C} and {F}_{out}^{high} ∈ {R}^{N \times 2 C} ,$$

and they are reconstructed to form

$${F}_{out}^{low} ∈ {R}^{NC} and {F}_{out}^{high} ∈ {R}^{2 NC} .$$

Such feature vectors are used to predict low-level and high-level subtypes of renal tumors (for example, ŷ^{low} and ŷ^{high}), which are given with the following mathematical expression 5.

$$\begin{matrix}{\hat{y}}^{low} = softmax ( FFN ( {f}_{out}^{low} ) ) , \\ {\hat{y}}^{high} = softmax ( FFN ( {f}_{out}^{high} ) ) .\end{matrix} \qquad [ Mathematical expression 5 ]$$

A final tumor subtype prediction result ŷ^{final} is acquired as a weighted average between the low-level tumor subtype prediction and the high-level tumor subtype prediction, which is given with the following mathematical expression 6.

$${\hat{y}}^{final} = α {\hat{y}}^{low} + ( 1 - α ) {\hat{y}}^{high} \qquad [ Mathematical expression 6 ]$$

In this case, the ais a hyperparameter for balancing the low-level prediction and the high-level prediction.

Lastly, training of the multi-scale model is supervised by a total segmentation loss L of all of scales, which is formulized with the following mathematical expression 7.

$$ℒ = {ℒ}_{CE} ( {\hat{y}}^{low} , y ) + {βℒ}_{CE} ( {\hat{y}}^{high} , y ) \qquad [ Mathematical expression 7 ]$$

In this case, the L_{CE} is a cross entropy loss between the subtype prediction result and a real subtype label, and the β is a hyperparameter for balancing two loss conditions.

Further, as shown in FIG. 5, a baseline network for the 3D multi-phase CT images is constructed to use the multi-phase CT images as inputs and processes volumetric CT data through the 3D CNN. In detail, the baseline network is constructed by deleting the cross-phase attention module and the multi-scale attention method of the tumor subtype classification apparatus of FIG. 3.

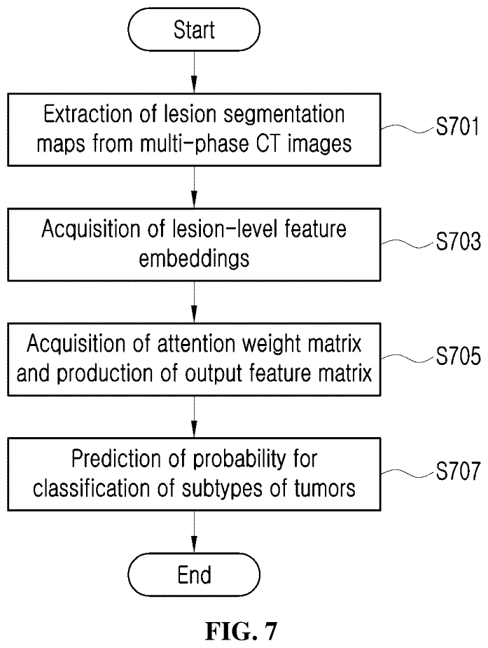

FIG. 7 is a flowchart showing a method for classifying subtypes of tumors according to the present disclosure.

First, a method for classifying subtypes of tumors according to the present disclosure includes the steps of extracting lesion segmentation maps from multi-phase CT images (in step S701) and acquiring lesion-level feature embeddings using the CT images and the lesion segmentation maps (in step S703).

Next, the method for classifying subtypes of tumors according to the present disclosure includes: the steps of acquiring an attention weight matrix representing interdependence of multi-phase pairwise lesion features using the feature embeddings acquired in the step S703 and combining the feature embeddings acquired in the step S703 and the attention weight matrix to produce an output feature matrix (in step S705).

After that, the method for classifying subtypes of tumors according to the present disclosure includes: the step of predicting a probability for the classification of the subtypes of tumors, based on the output feature matrix produced in the step S705 (in step S707).

Meanwhile, the method for classifying subtypes of tumors according to the present disclosure as described above may be implemented in the form of a program instruction that can be performed through various computers, and may be recorded in a computer readable recording medium including non-transitory computer readable recording medium. The computer readable medium may include a program command, a data file, a data structure, and the like independently or in combination.

The program instruction recorded in the recording medium is specially designed and constructed for the present disclosure, but may be well known to and may be used by those skilled in the art of computer software.

The computer readable recording medium may include a magnetic medium such as a hard disc, a floppy disc, and a magnetic tape, an optical recording medium such as a Compact Disc Read Only Memory (CD-ROM) and a Digital Versatile Disc (DVD), a magneto-optical medium such as a floptical disk, and a hardware device specifically configured to store and execute program instructions, such as a Read Only Memory (ROM), a Random Access Memory (RAM), and a flash memory.

Further, the program command may include a machine language code generated by a compiler and a high-level language code executable by a computer through an interpreter and the like. The hardware device may be configured to operate as one or more software modules in order to perform operations of the present disclosure, and vice versa.

As described above, the apparatus and method according to the present disclosure can classify the subtypes of tumors on the multi-phase CT images, thereby improving a degree of accuracy in the differential diagnosis of the subtypes of tumors.

Further, the apparatus and method according to the present disclosure can classify the subtypes of tumors accurately to allow optimal treatment planning to be built for a patient so that the patient's prognosis can be predicted well and customized patient treatment planning can be built.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for classifying subtypes of tumors, the apparatus comprising:
a lesion segmentation network processor to extract lesion segmentation maps from multi-phase CT images;
a lesion-level feature embedding processor to acquire lesion-level feature embeddings using the multi-phase CT images and the lesion segmentation maps;
a cross-phase attention processor to acquire an attention weight matrix representing interdependence of multi-phase pairwise lesion features using the lesion-level feature embeddings and to combine the lesion-level feature embeddings and the attention weight matrix to produce an output feature matrix; and
a feed forward network processor to predict a probability for classification of the subtypes of tumors through an input of the output feature matrix.

2. The apparatus according to claim 1, wherein the lesion-level feature embedding processor is configured to produce a plurality of feature maps from the multi-phase CT images and to transform the plurality of feature maps into queries, keys, and values using the lesion segmentation maps to acquire the lesion-level feature embeddings.

3. The apparatus according to claim 1, wherein the lesion-level feature embedding processor is configured to embed first level features of a first level and second level features of a second level higher than the first level to acquire first level feature embeddings and second level feature embeddings, the first level feature embeddings being acquired using the lesion segmentation maps and the second level feature embeddings being acquired using maps downsampled from the lesion segmentation maps.

4. The apparatus according to claim 2, wherein the cross-phase attention processor is configured to add phase embeddings to the queries and keys, calculate scaled dot products between the queries and keys to which the phase embeddings are added, and apply a softmax function to the scaled dot products to acquire the attention weight matrix.

5. The apparatus according to claim 4, wherein the cross-phase attention processor is configured to add the phase embeddings to the values and multiply the values to which the phase embeddings are added with the attention weight matrix to produce the output feature matrix.

6. The apparatus according to claim 2,
wherein the attention weight matrix comprises an attention weight matrix of a first level and an attention weight matrix of a second level higher than the first level, and
wherein the cross-phase attention processor is configured to combine the values to the attention weight matrix of the first level to produce the output feature matrix of the first level and combine the values to the attention weight matrix of the second level to produce the output feature matrix of the second level.

7. The apparatus according to claim 6, wherein the feed forward network processor is configured to predict a first level tumor subtype using vectors reconstructing the output feature matrix of the first level, predict a second level tumor subtype using vectors reconstructing the output feature matrix of the second level, and acquire a final tumor subtype prediction result with a weighted average between the first level tumor subtype and the second level tumor subtype.

8. A method for classifying subtypes of tumors, the method comprising:
extracting lesion segmentation maps from multi-phase CT images;
acquiring lesion-level feature embeddings using the multi-phase CT images and the lesion segmentation maps;
acquiring an attention weight matrix representing interdependence of multi-phase pairwise lesion features using the lesion-level feature embeddings and combining the lesion-level feature embeddings and the attention weight matrix to produce an output feature matrix; and
predicting a probability for classification of the subtypes of tumors through an input of the output feature matrix.

9. The method according to claim 8, wherein the acquiring the lesion-level feature embeddings comprises:
producing a plurality of feature maps from the multi-phase CT images and transforming the plurality of feature maps into queries, keys, and values using the lesion segmentation maps to acquire the lesion-level feature embeddings.

10. The method according to claim 8, wherein the acquiring the lesion-level feature embeddings is performed by embedding first level features of a first level and second level features of a second level higher than the first level to acquire first level feature embeddings and second level feature embeddings, the first level feature embeddings being acquired using the lesion segmentation maps and the second level feature embeddings being acquired using maps downsampled from the lesion segmentation maps.

11. The method according to claim 9, wherein the attention weight matrix is acquired by adding phase embeddings to the queries and keys, calculating scaled dot products between the queries and keys to which the phase embeddings are added, and applying a softmax function to the scaled dot products.

12. The method according to claim 11, wherein the producing the output feature matrix comprises:
adding the phase embeddings to the values and multiplying the values to which the phase embeddings are added with the attention weight matrix to produce the output feature matrix.

13. The method according to claim 9,
wherein the attention weight matrix comprises an attention weight matrix of a first level and an attention weight matrix of a second level higher than the first level, and
wherein the producing the output feature matrix comprises combining the values to the attention weight matrix of the first level to produce the output feature matrix of the first level and combining the values to the attention weight matrix of the second level to produce the output feature matrix of the second level.

14. The method according to claim 13, wherein the predicting the probability for the classification of the subtypes of tumors comprises:
predicting a first level tumor subtype using vectors reconstructing the output feature matrix of the first level, predicting a second level tumor subtype using vectors reconstructing the output feature matrix of the second level, and acquiring a final tumor subtype prediction result with a weighted average between the first level tumor subtype and the second level tumor subtype.
